(19) United States
(12) Patent Application Publication
(10) Pub. No.: US 2025/0054176 A1
(43) Pub. Date: Feb. 13, 2025

(54) BOUNDING BOX TRANSFORMATION FOR OBJECT DEPTH ESTIMATION IN A MULTI-CAMERA DEVICE

(71) Applicant: Snap Inc., Santa Monica, CA (US)

(72) Inventors: Evangelos Chatzikalymnios, Vienna (AT); Thomas Faeulhammer, Vienna (AT); Ihor Tymchyshyn, Kyiv (UA); Daniel Wolf, Mödling (AT)

(21) Appl. No.: 18/475,720

(22) Filed: Sep. 27, 2023

(30) Foreign Application Priority Data
Aug. 10, 2023 (GR) 20230100669

(51) Int. Cl. G06T 7/70; G06T 3/40; G06T 7/20; G06T 7/62; G06V 10/25; G06V 40/20

(52) U.S. Cl. CPC G06T 7/70; G06T 3/40; G06T 7/20; G06T 7/62; G06V 10/25; G06V 40/28; G06V 2201/07

(57) ABSTRACT

A device includes a processor, image sensors, and memory storing instructions to obtain images from the sensors and process a first image to identify coordinates of a bounding box around an object. The device processes the area within the first box to determine 2-D positions of landmarks associated with the object, derives first 3-D positions of the landmarks, and determines coordinates of a second box bounding the object in the second image using the 3-D landmark positions. The device processes the area within the second box to determine 2-D positions of landmarks and uses triangulation to derive second 3-D positions of the landmarks. Overall, the device obtains images, detects objects and landmarks, determines 2-D and 3-D positions of landmarks, and triangulates 3-D positions.

### CLAIM OF PRIORITY

This application claims the benefit of priority to Greece Patent Application Serial No. 20230100669, filed on Aug. 10, 2023, which is incorporated herein by reference in its entirety.

### TECHNICAL FIELD

The present application relates to a technique in the field of computer vision systems. More precisely, the present application describes a technique that relates to a subfield of computer vision systems that deals with depth estimation, which is the process of inferring the distances of objects in a real-world scene.

### BACKGROUND

Computer vision systems are systems that use algorithms and techniques to enable computers to interpret and analyze visual data from the world around us. These systems can be designed to analyze video to recognize objects, people, and other visual patterns, and to extract useful information from visual data in a wide range of contexts. Computer vision systems typically involve a combination of hardware and software components. The hardware may include image sensors (e.g., cameras) for capturing images and video, while the software includes algorithms for processing and analyzing the captured images and video. Computer vision systems can be used in a variety of applications, such as augmented reality (AR), autonomous vehicles, robotics, security and surveillance, medical imaging, and more. In each of these applications, one of the more common tasks performed by a computer vision system is determining the location of an object, in three dimensions, relative to some origin or reference point, for example, by estimating the depth of the object detected in a real-world scene.

In the realm of AR, the depth of an object may be detected in relation to a head-worn AR device (e.g., AR glasses). Obtaining an accurate representation of the depth, and location, of an object is particularly important in AR applications. An accurate depth estimation allows for tracking real-world objects and rendering virtual objects so that the virtual objects are properly positioned and appear realistic within the real-world scene. For example, when virtual objects are rendered with proper depth information, they appear to be in the correct position relative to real-world objects. This enhances the visual coherence and immersion of the AR experience, making virtual content seamlessly integrate with the user's surroundings.

### BRIEF DESCRIPTION OF THE DRAWINGS

In the drawings, which are not necessarily drawn to scale, like numerals may describe similar components in different views. To easily identify the discussion of any particular element or operation, the most significant digit or digits in a reference number refer to the figure number in which that element is first introduced. Some non-limiting examples are illustrated in the figures of the accompanying drawings in which:

FIG. 1 illustrates a conventional technique for determining the depth of a real-world object, using a multi-camera, augmented reality (AR) device.

FIG. 2 illustrates a technique for determining the depth of a real-world object using a multi-camera device, where the region of interest in one image is determined from a region of interest in another image, consistent with some embodiments of the present invention.

FIG. 3 illustrates an example of how a 3-D pose estimator is used to derive 3-D positioning data for one or more landmarks associated with an object, using as input 2-D positioning data for the one or more landmarks, consistent with some embodiments of the invention.

FIG. 4 is a block diagram illustrating an example of the functional components (e.g., hardware components) of an AR device (e.g., AR glasses) with which the methods and techniques described herein, may be implemented, consistent with embodiments of the present.

FIG. 5 is a block diagram illustrating a software architecture, which can be installed on any one or more of the devices described herein.

### DETAILED DESCRIPTION

Described herein are methods, systems, and computer program products, for determining the location of an object by estimating the depth of the object (e.g., a human hand, body, or portion thereof) observed with a multi-camera, augmented reality (AR) device. In the following description, for purposes of explanation, numerous specific details are set forth to provide a thorough understanding of the various aspects of different embodiments of the present invention. It will be evident, however, to one skilled in the art, that the present invention may be practiced without all of these specific details.

In an AR application-particularly, an AR application for a head-worn AR device, such as AR glasses-estimating the depth of an object and thus determining the precise location of an object, is important for a number of reasons. For instance, estimating the depth of an object is important as it allows the AR device to accurately track real-world objects and to properly render virtual content (e.g., virtual objects), and thus, to realistically augment a real-world scene. If the size of a particular real-world object is known in advance, for example, because an AR device has access to an accurate three-dimensional (3D) model of the particular object (e.g., a specific user's hand), then the depth of that particular object can be accurately determined by analyzing a single image (or, video frame) depicting the object. However, when the size of an object is unknown in advance, as is often the case with random human body parts (e.g., hands and heads), an AR device may only be able to calculate a rough estimate of the depth of the object, using an estimate of the actual size of the object. For example, if the object is a human hand, the AR device may use the average size of a human hand as an estimate for the actual size of a hand that is depicted in a single image, in an attempt to determine the depth or distance of the hand.

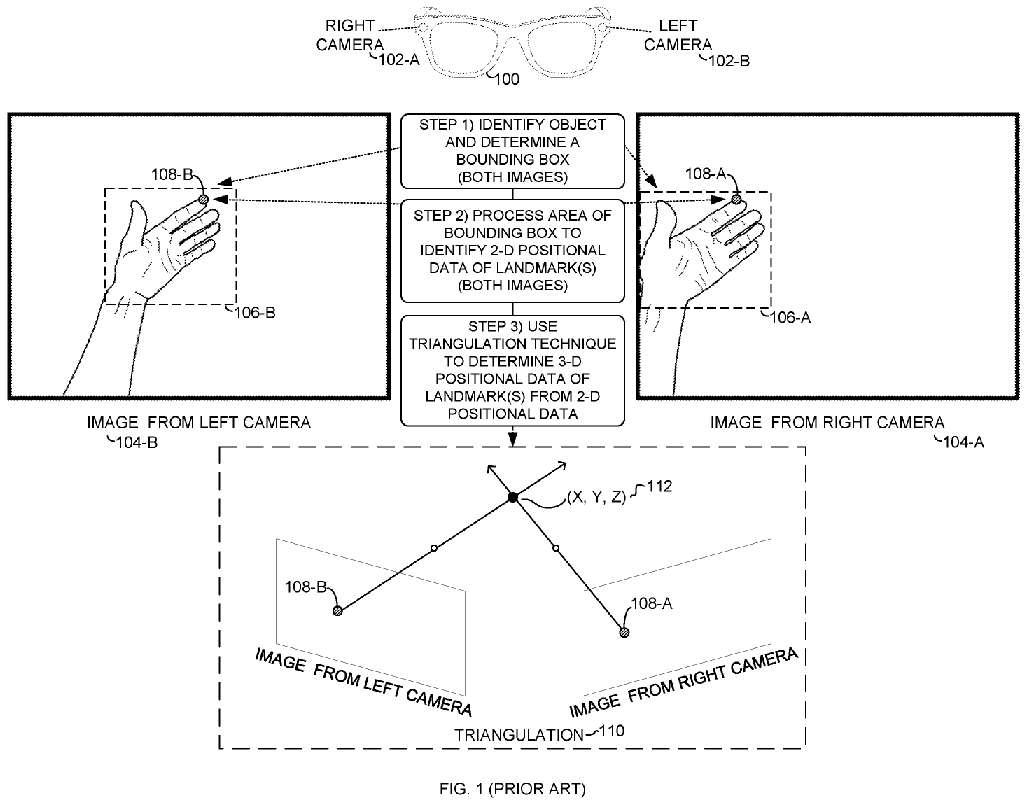

Because of the challenges involved in accurately estimating the depth of an object from a single image, many AR devices use an alternative approach that relies on triangulation in a multi-camera setup. Such an approach is illustrated in FIG. 1. As illustrated in FIG. 1, consistent with this approach, an AR device 100 includes two calibrated cameras 102-A and 102-B, each with known intrinsic parameters (e.g., focal length, principal point, lens distortion model) and extrinsic parameters (baseline, relative position and orientation). As each camera captures images, two corresponding images are processed-a first image 104-A obtained with the right camera 102-A, and a second image 104-B obtained with the left camera 102-B. The two images 104-A and 104-B are analyzed using one or more computer vision algorithms (e.g., an object detection or bounding box algorithm) to first identify an object (e.g., a hand) depicted in each image, and then to establish a region of interest 106-A and 106-B or bounding box that geometrically encloses the identified object, in each image. Here, an object detection algorithm (e.g., a bounding box algorithm) is primarily concerned with localizing and outlining the extent or boundaries of a region of interest within an image or video frame, where the region of interest encloses the object of interest.

Once the coordinates of the bounding boxes 106-A and 106-B have been determined for the object in each of the two images, the portion of each image corresponding with a respective bounding box 106-A and 106-B is processed using one or more computer vision algorithms in order to identify one or more features of the object, or in the case of certain objects (e.g., a hand), one or more distinct two-dimensional (2-D) landmarks. As shown in FIG. 1, during the second processing step, the tip of the pointer finger on the hand is identified as a 2-D landmark 108-A and 108-B in each of the separate images 104-A and 104-B. In this example, only a single landmark is shown. However, in actual practice, several 2-D landmarks may be identified.

Once the 2-D positional data for the corresponding (e.g., matching) 2-D landmarks 108-A and 108-B for the object has been determined, using the geometry of the AR device and its calibrated cameras, a triangulation technique 110 is applied to calculate the three-dimensional (3-D) positional data of the landmark. For example, to estimate the depth of the landmark, the AR device calculates the rays emanating from the camera centers through the corresponding 2-D landmark in each image. These rays represent the visual projection lines for each landmark. By applying triangulation, the system intersects the corresponding rays from the two camera viewpoints. The point of intersection represents the 3-D position of the object in the real world. This triangulated point provides an accurate estimation of the landmark's position in 3-D space, to the extent that the accuracy of position of the landmark is not dependent upon the size estimate of the object. By determining 3-D positional data of several landmarks, an accurate estimation of the object's position in 3-D space can be derived.

The accuracy of the calculated 3-D positional data 112 of the landmark is highly impacted and mostly determined by the accuracy of the measurement of the positional data of the associated 2-D landmarks 108-A and 108-B. The positional data of the 2-D landmarks is generally determined by a computer vision algorithm that processes each image separately, and specifically the portion of each image that corresponds with a respective bounding box for the object in the image. By limiting the operation or processing of the landmark detection algorithm to the area of the image defined by the bounding box, the overall accuracy in detecting landmarks is significantly improved, while simultaneously reducing the required processing time and power that is required to identify the landmark(s). Therefore, determining the bounding box of an object in an image with a bounding box detection algorithm is an important processing step in various computer vision tasks, such as object detection and tracking. By determining the position of a bounding box for an object in an image, the landmark search space is reduced, thereby leading to increased accuracy in the determination of landmark positions while reducing runtime (e.g., processing time) and power requirements. With a head-worn AR device, which may be battery powered, the use of a bounding box may also preserve battery longevity.

While using a bounding box detection algorithm has its advantages, executing the bounding box detection algorithm to predict the position of a bounding box of an object comes at a high cost in terms of both runtime (e.g., processing time) and power consumption. Furthermore, in many instances, each image may depict multiple objects. For example, in the context of an AR application for a head-worn AR device, the AR application may track both hands of an end-user wearing the AR device (as opposed to one hand, as illustrated in FIG. 1). When tracking multiple objects, each image may depict multiple objects (e.g., two hands), and thus, the bounding boxes in each image may overlap. As the bounding boxes for each object overlap within a single image, it may become more difficult to identify corresponding bounding boxes between the separate images.

Described herein is a technique for determining the position of an object in 3-D space with a multi-camera device such, as a head-worn AR device, where the region of interest in a second image is determined from a region of interest in a first image. With a conventional depth estimation technique, given a pair of corresponding images or video frames, a bounding box detection algorithm is applied twice-one time for each of the two separate images or frames. Consistent with embodiments of the present invention, the need for performing the bounding box detection process twice-once for each image or frame—is eliminated, thereby reducing processing time and power. Instead, the bounding box algorithm is applied a first time, to a first image of a corresponding pair of images. Then, the area of the first image defined by the bounding box is analyzed using a landmark detection algorithm, which determines 2-D positional data for one or more landmarks associated with an object depicted in the area defined by the bounding box. The 2-D positional data of the one or more landmarks are provided as input to a 2-D to 3-D lifter—a type of deep neural network that generates 3-D positional information from 2-D positional information. The resulting 3-D positional information for the one or more landmarks is then used, along with the known parameters of the cameras of the AR device, to project a bounding box in the second image. Once the bounding box has been projected for the second image, the area of the second image that corresponds with the bounding box is processed with a 2-D landmark detection algorithm to generate 2-D positional data for the landmarks, as depicted in the second image. Finally, the 2-D positional data of the landmarks obtained from processing the first image, and the 2-D positional data of the landmarks obtained from processing the second image are used as inputs to a triangulation process, which utilizes the parameters of the device to generate accurate 3-D positional data for the landmarks, and thus the object with which the landmarks are associated.

Consistent with embodiments of the invention, because the bounding box detection algorithm, or bounding box detector, is only applied once, to one image in a pair of images, the processing time and power are reduced without sacrificing the added accuracy that results from limiting the area of an image in which a 2-D landmark search is performed. While the technique described herein is presented in the context of a head-worn AR device, such as an AR headset or AR glasses, those skilled in the art will readily recognize that the innovative technique described herein may be applicable in a wide variety of other applications, use cases and contexts. Other aspects and advantages of the present invention are conveyed via the descriptions of the several figures that follows.

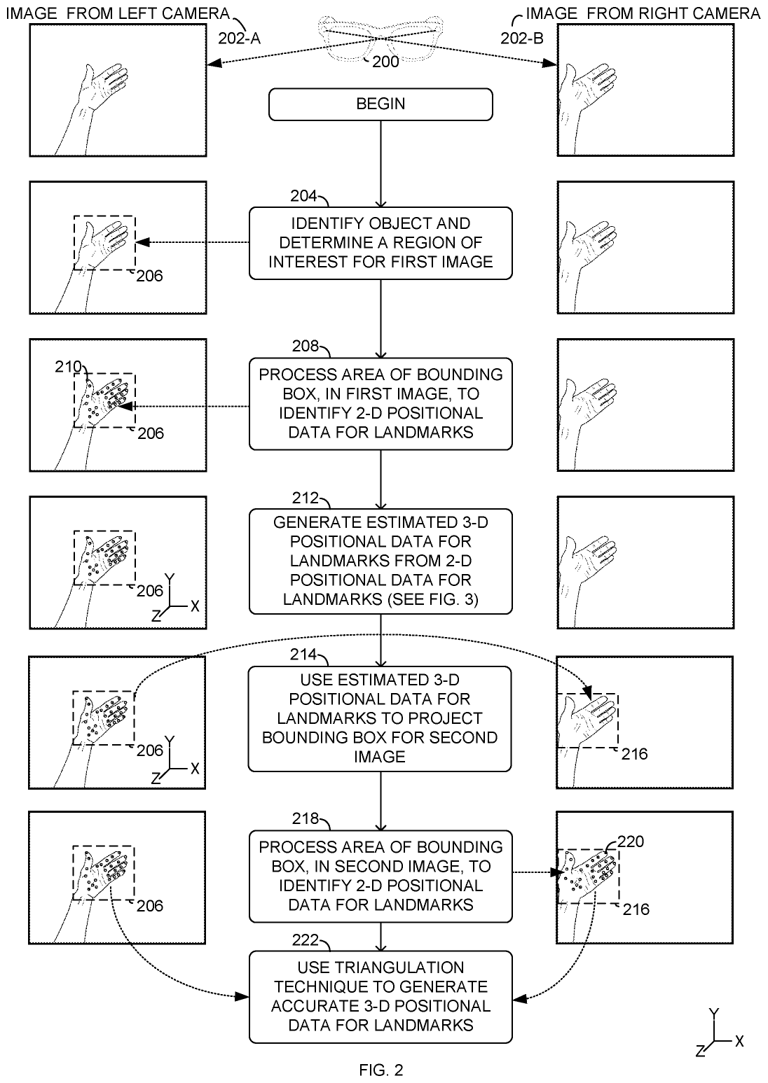

FIG. 2 illustrates an improved technique for determining the depth of a real-world object, using a multi-camera device, consistent with some embodiments of the present invention. The technique illustrated in FIG. 2 begins when a multi-camera device, such as a pair of head-worn AR glasses 200, obtains a first image 202-A from a first camera or image sensor, and a second image 202-B from a second camera or image sensor. The two images are corresponding images in the sense that the two images are captured at the same time and depict the same real-world scene—although, from a slightly different perspective. For instance, the two cameras are typically positioned at different locations on the AR device, which results in a slight variation in the viewpoints from which they capture the real-world scene. Although referred to herein as images, the images may be individual frames of a sequence of frames captured by each camera as a video stream.

### Identify Object and Determine a Bounding Box for First Image

After the two corresponding images have been obtained, the next step 204 involves processing one image 202-A in the pair of images (e.g., 202-A and 202-B) by identifying one or more objects of interest within the image 202-A, and determining a bounding box for each object of interest identified within the image. This is achieved by applying to the image 202-A a bounding box detection algorithm, or bounding box detector. In the example presented in FIG. 2, the object of interest is a hand. Accordingly, in the image 202-A captured by the left camera, the result of the second step 204 is the rectangular box 206, shown to be bounding or enclosing the hand of the person wearing the AR device 200 as depicted in the image 202-A. In this example, the bounding box detector is applied to just one of the two corresponding images—in this case, the image 202-A captured by the left camera. However, it should be noted that the specific image-left or right—is not critical. What is important is that the bounding box detector is applied to only a first image, and then the position of the bounding box in the first image is used to determine the location of a bounding box in one or more corresponding images, thereby reducing the overall processing time and power.

A bounding box detector or bounding box detection algorithm is a computer vision algorithm or technique that aims to identify and localize objects of interest within an image by enclosing them with rectangular bounding boxes. The algorithm automatically determines the position and extent of objects based on their visual characteristics. Initially, the bounding box detection algorithm generates a set of potential object proposals or candidate regions within the image that are likely to contain objects. Various methods can be used for generating these proposals, such as selective search, region proposal networks (RPN), or sliding window approaches. The bounding box detection algorithm extracts relevant features from the proposed regions or the entire image. These features can be based on color, texture, shape, or other visual attributes. Common techniques include using convolutional neural networks (CNNs) to extract deep features from the image. The extracted features are then used to classify whether each proposed region contains the object of interest (e.g., a hand, a human body, a head) or not. This typically involves training a classifier, such as a support vector machine (SVM), random forest, or deep neural network, on a labeled dataset to learn the distinguishing characteristics of the object class. After classifying the object presence, the bounding box detection algorithm refines the bounding boxes by adjusting their positions and sizes. This regression step helps to improve the accuracy of the bounding box localization by estimating the precise boundaries of the identified objects. The output of the object detection algorithm is a region of interest that defines the (approximate) position of an object within the image, for example, by a bounding box or pixel-wise segmentation, along with a corresponding class label and/or confidence score. Popular bounding box detection algorithms include Faster R-CNN, YOLO (You Only Look Once), SSD (Single Shot MultiBox Detector), and RetinaNet. Of course, other algorithms may be used.

### Process Bounding Box to Identify 2-D Positional Data of Landmarks

After the one or more bounding boxes have been identified for the first image 202-A, the next step 208 involves applying another computer vision algorithm, referred to as a 2-D landmark detection algorithm or landmark detector, to identify within the area of each identified bounding box the 2-D positional data of various landmarks. As shown in FIG. 2, the hand depicted in the image 202-A has been annotated with landmark markers to indicate the position in the image at which each landmark was detected. These landmark markers are visual indicators that highlight the specific points of interest or key landmarks on the hand, such as fingertips, knuckles, or joints. For example, the landmark marker with reference number 210 indicates the position of the landmark for the tip of the thumb.

A 2-D landmark detection algorithm or landmark detector, sometimes referred to as a keypoint detection or keypoint localization algorithm, is a computer vision algorithm that aims to identify and localize specific points of interest, referred to as landmarks or keypoints, within an image. These landmarks are distinctive and meaningful positions that can be used as references for further analysis or interaction. In the context of an augmented reality (AR) application for identifying a hand or other body parts, a 2-D landmark detection algorithm is used to detect and localize the points on the hand, such as fingertips, palm center, joints, or other anatomical landmarks.

A 2-D landmark detection algorithm is typically trained on a labeled dataset where manual annotations or ground truth landmarks are provided for each hand or body part image. The dataset may include various hand or body poses, viewpoints, and conditions to capture the variability of real-world scenarios. The algorithm extracts relevant features from the input image or image region around the hand or body part. These features can be based on color, texture, gradient, or other visual attributes that help distinguish and localize the landmarks accurately. Using the extracted features, the 2-D landmark detection algorithm predicts the positions or 2-D coordinates of the landmarks within the image. This can involve regression, classification, or a combination of both techniques, depending on the algorithm architecture. Machine learning techniques like deep neural networks, CNNs, or recurrent neural networks (RNNs) are often used to learn the mapping between image features and landmark locations. After landmark localization, post-processing techniques may be applied to refine the results, remove outliers, or enforce geometric constraints. These techniques can include filtering, smoothing, or statistical methods to improve the accuracy and robustness of the detected landmarks. The output of the 2-D landmark detection algorithm is a set of coordinates representing 2-D positional data for localized landmarks that represent the identified hand or body part within the image.

Generate Estimated 3-D Positional Data from 2-D Positional Data

After the 2-D positional data of the landmarks for each object have been detected in the first image, the next step 214 involves using a 3-D pose estimator to generate estimated 3-D positional data for the landmarks, using the 2-D positional data of the landmarks. While there are several techniques that may be used, with some embodiments, a 2-D to 3-D lifter network-a specific type of deep neural network—is used to generate the estimated 3-D positional data for the landmarks, using as input at least the 2-D positional data of the landmarks, and in some cases, an estimate of the size of the object. Note, at this point, the size of the object is not known, and thus an estimate may be used. Accordingly, the accuracy of the estimated 3-D positional data of the landmarks, as initially derived by the monocular pose estimator, is referred to herein as being “estimated” as the results are generally not as accurate as the final results, derived via a triangulation process (described in greater detail below). Moreover, once the triangulation process has been completed and the size of the object has been determined through the triangulation process, subsequent estimations performed by the monocular pose estimator may include as input the size of the object, rendering the estimates of the 3-D positional data more accurate than in the initial stage, where the actual size of the object is unknown.

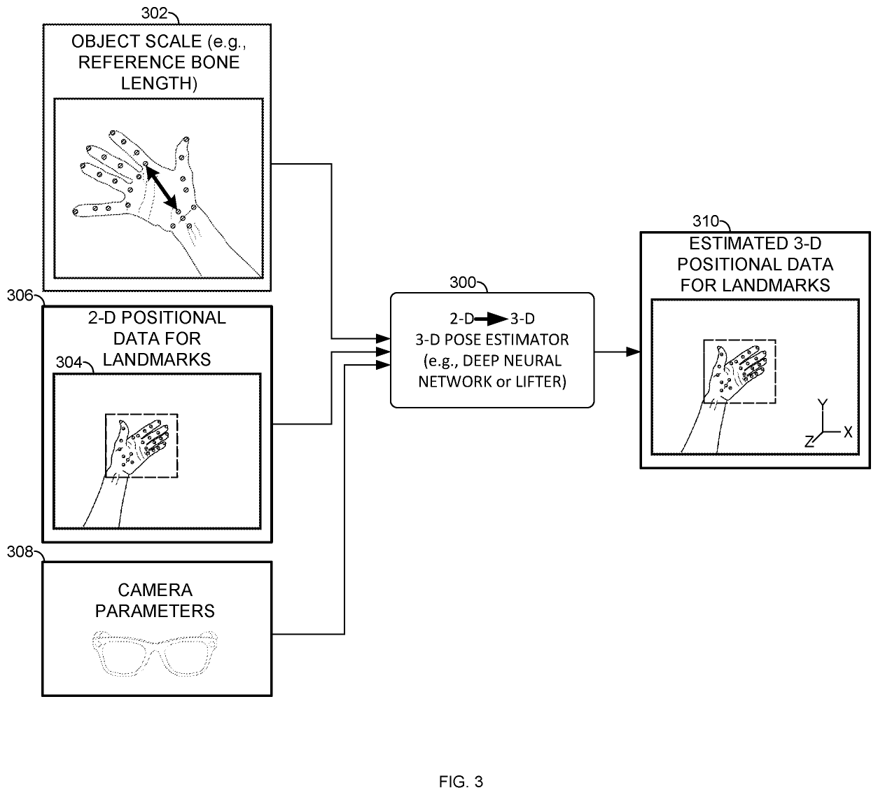

As illustrated in FIG. 3, consistent with some embodiments, a 2-D to 3-D lifter network 300, a deep neural network, is used to generate 3-D positional data for the landmarks 310 associated with the hand, given 2-D positional data for the landmarks 304, as obtained from analyzing a single image 306. The input to the lifter network 300 consists of the image 306, including the 2-D positional data of the landmarks 304 of the object detected in the image. In this example, the 2-D positional data represent the detected landmarks on the hand in the first (left camera) image 202-A. Additionally, the camera parameters 308, such as the intrinsic camera matrix containing focal length and principal point, may be provided as input to the network 300. Optionally, with some embodiments, an object scaling factor 302 associated with a detected object (e.g., a reference bone measurement, in the case where the object is a hand) may be provided as an input to the lifter network 300. Here, in the example presented in FIG. 3, the average length of a reference bone 302 in a hand, such as the length between two specific landmarks, can be included as input to help scale the resulting 3-D positions.

The lifter network 300 performs feature extraction on the input data to capture meaningful representations. This may involve convolutional layers to extract hierarchical visual features from the 2-D landmark positions and camera parameters. The lifter network 300 can also incorporate other layers, such as fully connected layers or recurrent layers, to capture more complex relationships and dependencies within the data.

The lifter network 300 uses the extracted features to estimate the depth or 3-D positional data for each landmark. It learns the mapping between the 2-D positional data and the corresponding depth values. By leveraging the camera parameters, the lifter network 300 can take into account the perspective distortion and project the 2-D positional data into 3-D space. The reference bone length, if provided, can help in scaling the estimated 3-D positional data to the appropriate size.

The output of the lifter network 300 is the generated 3-D positional data for each landmark. These 3-D positions represent the estimated spatial locations of the landmarks within the 3-D coordinate system defined by the camera(s). The positions are typically represented as 3-D coordinates (X, Y, Z) relative to a chosen reference point or origin.

The lifter network 300 is trained on a dataset containing annotated pairs of 2-D landmark positions and corresponding ground truth 3-D positions. The lifter network 300 learns to predict accurate 3-D positional data based on the input 2-D positional data, camera parameters, and, if available, a reference bone length. Training involves optimizing the network's parameters to minimize the discrepancy between the predicted 3-D positions and the ground truth positions. Through this process, the 2-D to 3-D lifter network utilizes deep learning techniques to transform the 2-D positional data of hand landmarks, along with camera parameters and optionally a reference bone length, into 3-D positional data.

### Projecting a Second Bounding Box

Referring again to FIG. 2, after the estimated 3-D positional data for the landmarks are determined, the next step 214 involves using the 3-D positional data for the landmarks to project a bounding box into the 2-D space of the second image 202-B, where the objective is to ensure that this second bounding box 216 encloses the object (e.g., the hand) as depicted in the second image 202-B. Using the estimated 3-D positional data of the object (e.g., the hand) obtained from processing the first image 202-A, a transformation is applied to align the 3-D landmarks with the perspective of the left camera, using what is referred to as the rigid transformation matrix. For example, this transformation involves using the extrinsic parameters that define the relationship between the two cameras, such as the rotation and translation between their coordinate systems. This transformation can be expressed as follows,

X_{Second}=K*T_{Second←Main}X_{Main}

Here, X_{Second} are the undistorted (homogenous) pixel coordinates in the second image, K is the intrinsic matrix, T_{Seconde←Main} is the rigid transformation (camera extrinsics), and X_{Main} are the (homogenous) 3-D coordinates of the landmark in the main camera reference frame.

In a multi-camera device, the rigid transformation matrix “T” facilitates converting points (e.g., landmarks) from one camera's coordinate system to the other camera's coordinate system and vice versa. By applying this transformation, correspondences between the two camera images can be established, and triangulation can be performed to estimate the 3-D positional data of objects in the scene. The camera matrix, “K,” represents the intrinsic parameters of a camera, which describe its internal properties and characteristics. The intrinsic parameters are used to relate the 3-D world coordinates of a scene to their corresponding 2-D pixel coordinates. By using the camera matrix, “K,” along with the transformation matrix, “T,” it is possible to project 3-D positional data to determine the 2-D positional data for the second bounding box 216, associated with the second camera's image plane or coordinate system.

Consistent with some embodiments, the exact coordinates of the second bounding box 216 may be determined by computing the smallest rectangle enclosing all of the 3-D to 2-D projected landmarks. Alternatively, with some embodiments, only a subset of the landmarks (or even a single landmark, representing the centroid) may be projected into the coordinate space or image plane of the second image, and the size of the bounding box may be assumed equivalent to the size of the bounding box in the first image (e.g., the image from the left camera 202-A). With some embodiments, to account for potential inaccuracies in deriving the estimated 3-D positional data by the lifter network, the second bounding box 216 may be expanded or enlarged by a predefined scaling factor.

### Apply the Landmark Detection Algorithm to the Second Bounding Box

After the second bounding box has been projected into the image plane of the second image (e.g., the image obtained from the right image sensor 202-A), the next step 218 involves processing the area of the second image represented by the second bounding box with the landmark detection algorithm or landmark detector—in the same manner as was done for the first image (e.g., the step with reference number 208)—to accurately identify the 2-D positional data for the landmarks of the object, as depicted tin the second image.

### Use Triangulation to Determine Accurate 3-D Positinoal Data for Landmarks

Finally, in the final step 222, the 2-D positional data for the landmarks, derived from analyzing the first image 202-A, and the 2-D positional data for the landmarks, derived from analyzing the second image 202-B, are used in a triangulation algorithm or process to derive the final 3-D positional data for the landmarks of the object. With the accurate 3-D positional data for the landmarks known, the AR device may leverage this data as an input to a number of different algorithms or processes, including object tracking, gesture detection, and displaying virtual content.

Although the example illustrated and described in connection with FIGS. 2 and 3 involve determining the 3-D positional data for a single object (e.g., a hand), those skilled in the art will readily appreciate that the techniques described herein are applicable to scenes in which multiple objects are being tracked, including objects other than hands.

### Example Augmented Reality (AR) Device

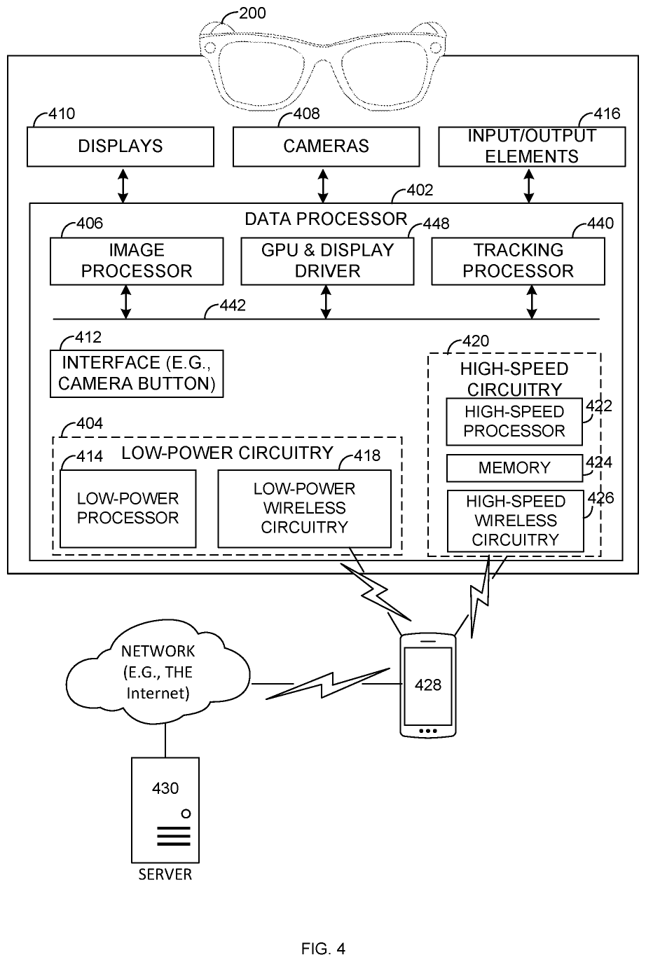

FIG. 4 is a block diagram illustrating an example of the functional components (e.g., hardware components) of an AR device (e.g., AR glasses 200) with which the methods and techniques described herein, may be implemented, consistent with embodiments of the present. Those skilled in the art will readily appreciate that the AR glasses 200 depicted in FIG. 4 are but one example of the many different devices to which the inventive subject matter may be applicable. For example, embodiments of the present invention are not limited to AR devices, but are also applicable to virtual reality devices and mixed reality devices.

The AR glasses 200 include a data processor 402, displays 410, two or more cameras 408, and additional input/output elements 416. The input/output elements 416 may include microphones, audio speakers, biometric sensors, additional sensors, or additional display elements integrated with the data processor 402. For example, the input/output elements 416 may include any of I/O components, including motion components, and so forth.

Consistent with one example, and as described herein, the displays 410 include a display for the user's left and right eyes. Each display of the AR glasses 200 may include a forward optical assembly (not shown) comprising a right projector and a right near eye display, and a forward optical assembly including a left projector and a left near eye display. In some examples, the near eye displays are waveguides. The waveguides include reflective or diffractive structures (e.g., gratings and/or optical elements such as mirrors, lenses, or prisms). Light emitted by the right projector encounters the diffractive structures of the waveguide of the right near eye display, which directs the light towards the right eye of a user to provide an image on or in the right optical element that overlays the view of the real world seen by the user. Similarly, light emitted by a left projector encounters the diffractive structures of the waveguide of the left near eye display, which directs the light towards the left eye of a user to provide an image on or in the left optical element that overlays the view of the real world seen by the user.

The data processor 402 includes an image processor 406 (e.g., a video processor), a graphics processor unit (GPU) & display driver 448, a tracking processor 440, an interface 412, low-power circuitry 404, and high-speed circuitry 420. The components of the data processor 402 are interconnected by a bus 442.

The interface 412 refers to any source of a user command that is provided to the data processor 402. In one or more examples, the interface 412 is a physical button that, when depressed, sends a user input signal from the interface 412 to a low-power processor 414. A depression of such button followed by an immediate release may be processed by the low-power processor 414 as a request to capture a single image, or vice versa. A depression of such a button for a first period of time may be processed by the low-power processor 414 as a request to capture video data while the button is depressed, and to cease video capture when the button is released, with the video captured while the button was depressed stored as a single video file. Alternatively, depression of a button for an extended period of time may capture a still image. In some examples, the interface 412 may be any mechanical switch or physical interface capable of accepting user inputs associated with a request for data from the cameras 408. In other examples, the interface 412 may have a software component, or may be associated with a command received wirelessly from another source, such as from the client device 428.

The image processor 406 includes circuitry to receive signals from the cameras 408 and process those signals from the cameras 408 into a format suitable for storage in the memory 424 or for transmission to the client device 428. In one or more examples, the image processor 406 (e.g., video processor) comprises a microprocessor integrated circuit (IC) customized for processing sensor data from the cameras 408, along with volatile memory used by the microprocessor in operation.

The low-power circuitry 404 includes the low-power processor 414 and the low-power wireless circuitry 418. These elements of the low-power circuitry 404 may be implemented as separate elements or may be implemented on a single IC as part of a system on a single chip. The low-power processor 414 includes logic for managing the other elements of the AR glasses 200. As described above, for example, the low-power processor 414 may accept user input signals from the interface 412. The low-power processor 414 may also be configured to receive input signals or instruction communications from the client device 428 via the low-power wireless connection. The low-power wireless circuitry 418 includes circuit elements for implementing a low-power wireless communication system. Bluetooth™ Smart, also known as Bluetooth™ low energy, is one standard implementation of a low power wireless communication system that may be used to implement the low-power wireless circuitry 418. In other examples, other low power communication systems may be used.

The high-speed circuitry 420 includes a high-speed processor 422, a memory 424, and a high-speed wireless circuitry 426. The high-speed processor 422 may be any processor capable of managing high-speed communications and operation of any general computing system used for the data processor 402. The high-speed processor 422 includes processing resources used for managing high-speed data transfers on the high-speed wireless connection 434 using the high-speed wireless circuitry 426. In some examples, the high-speed processor 422 executes an operating system such as a LINUX operating system or other such operating system. In addition to any other responsibilities, the high-speed processor 422 executing a software architecture for the data processor 402 is used to manage data transfers with the high-speed wireless circuitry 426. In some examples, the high-speed wireless circuitry 426 is configured to implement Institute of Electrical and Electronic Engineers (IEEE) 802.11 communication standards, also referred to herein as Wi-Fi. In other examples, other high-speed communications standards may be implemented by the high-speed wireless circuitry 426.

The memory 424 includes any storage device capable of storing camera data generated by the cameras 408 and the image processor 406. While the memory 424 is shown as integrated with the high-speed circuitry 420, in other examples, the memory 424 may be an independent standalone element of the data processor 402. In some such examples, electrical routing lines may provide a connection through a chip that includes the high-speed processor 422 from image processor 406 or the low-power processor 414 to the memory 424. In other examples, the high-speed processor 422 may manage addressing of the memory 424 such that the low-power processor 414 will boot the high-speed processor 422 any time that a read or write operation involving the memory 424 is desired.

The tracking processor 440 estimates a pose of the AR glasses 200. For example, the tracking processor 440 uses image data and corresponding inertial data from the cameras 408 and the position components, as well as GPS data, to track a location and determine a pose of the AR glasses 200 relative to a frame of reference (e.g., real-world scene). The tracking module 440 continually gathers and uses updated sensor data describing movements of the AR glasses 200 to determine updated three-dimensional poses of the AR glasses 200 that indicate changes in the relative position and orientation relative to physical objects in the real-world environment. The tracking processor 440 permits visual placement of virtual objects relative to physical objects by the AR glasses 200 within the field of view of the user via the displays 410.

The GPU & display driver 438 may use the pose of the AR glasses 200 to generate frames of virtual content or other content to be presented on the displays 410 when the AR glasses 200 are functioning in a traditional AR mode. In this mode, the GPU & display driver 438 generate updated frames of virtual content based on updated three-dimensional poses of the AR glasses 400, which reflect changes in the position and orientation of the user in relation to physical objects in the user's real-world environment.

One or more functions or operations described herein may also be performed in an application resident on the AR glasses 200 or on the client device 428, or on a remote server 430. Consistent with some examples, the AR glasses 200 may operate in a networked system, which includes the AR glasses 200, the client computing device 428, and a server 430, which may be communicatively coupled via the network. The client device 428 may be a smartphone, tablet, phablet, laptop computer, access point, or any other such device capable of connecting with the AR glasses 200 using a low-power wireless connection and/or a high-speed wireless connection. The client device 428 is connected to the server system 430 via the network. The network may include any combination of wired and wireless connections. The server 430 may be one or more computing devices as part of a service or network computing system.

### Software Architecture

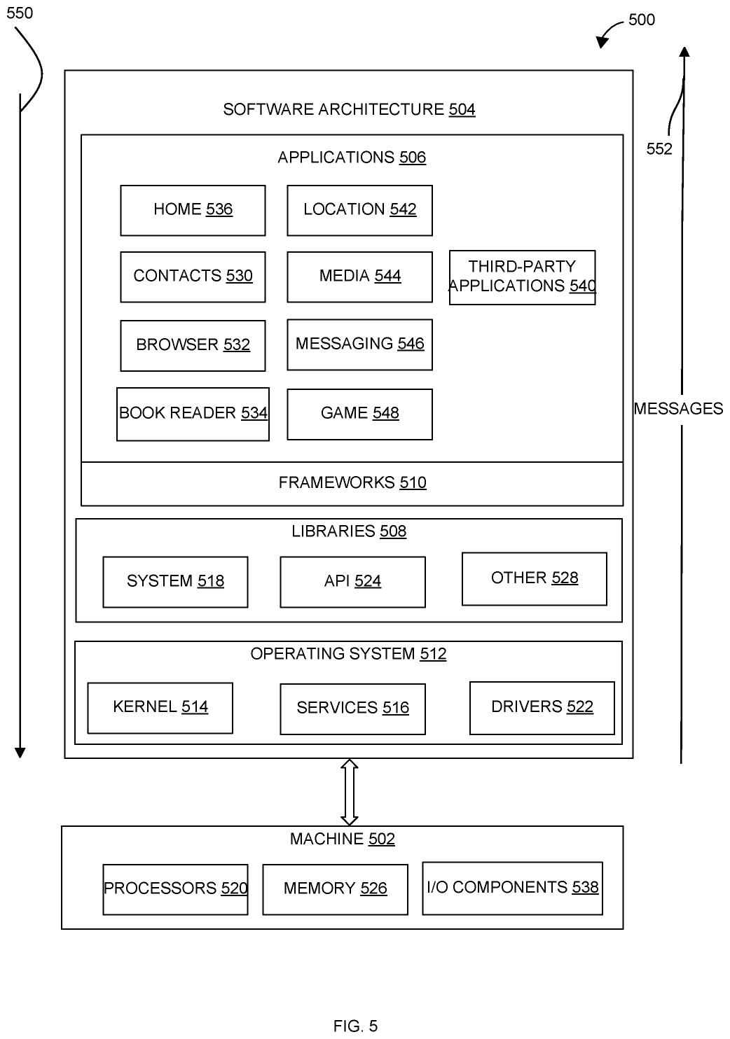

FIG. 5 is a block diagram 500 illustrating a software architecture 504, which can be installed on any one or more of the devices described herein. The software architecture 504 is supported by hardware such as a machine 502 that includes processors 520, memory 526, and I/O components 538. In this example, the software architecture 504 can be conceptualized as a stack of layers, where individual layers provides a particular functionality. The software architecture 504 includes layers such as an operating system 512, libraries 508, frameworks 510, and applications 506. Operationally, the applications 506 invoke API calls 550 through the software stack and receive messages 552 in response to the API calls 550.

The operating system 512 manages hardware resources and provides common services. The operating system 512 includes, for example, a kernel 514, services 516, and drivers 522. The kernel 514 acts as an abstraction layer between the hardware and the other software layers. For example, the kernel 514 provides memory management, processor management (e.g., scheduling), component management, networking, and security settings, among other functionalities. The services 516 can provide other common services for the other software layers. The drivers 522 are responsible for controlling or interfacing with the underlying hardware. For instance, the drivers 522 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 508 provide a low-level common infrastructure used by the applications 506. The libraries 508 can include system libraries 518 (e.g., C standard library) that provide functions such as memory allocation functions, string manipulation functions, mathematic functions, and the like. In addition, the libraries 508 can include API libraries 524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) graphic content on a display, GLMotif used to implement 3D user interfaces), image feature extraction libraries (e.g. OpenIMAJ), database libraries (e.g., SQLite to provide various relational database functions), web libraries (e.g., WebKit to provide web browsing functionality), and the like. The libraries 508 can also include a wide variety of other libraries 528 to provide many other APIs to the applications 506.

The frameworks 510 provide a high-level common infrastructure that is used by the applications 506. For example, the frameworks 510 provide various graphical user interface (GUI) functions, high-level resource management, and high-level location services. The frameworks 510 can provide a broad spectrum of other APIs that can be used by the applications 506, some of which may be specific to a particular operating system or platform.

In an example, the applications 506 may include a home application 536, a contacts application 530, a browser application 532, a book reader application 534, a location application 542, a media application 544, a messaging application 546, a game application 548, and a broad assortment of other Applications such as third-party applications 540. The applications 506 are programs that execute functions defined in the programs. Various programming languages can be employed to create one or more of the applications 506, structured in a variety of manners, such as object-oriented programming languages (e.g., Objective-C, Java, or C++) or procedural programming languages (e.g., C or assembly language). In a specific example, the third-party applications 540 (e.g., Applications developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party applications 540 can invoke the API calls 550 provided by the operating system 512 to facilitate functionality described herein.

### EXAMPLES

Example 1 is a device comprising: a processor; a first image sensor; a second image sensor; and a memory storing instructions thereon, which, when executed by the processor, cause the device to perform operations comprising: obtaining a first image from the first image sensor; obtaining a second image from the second image sensor; processing the first image with an object detector to identify coordinates of a first region of interest, the first region of interest indicating a position of an object depicted in the first image; processing the area of the first image corresponding with the first region of interest with a landmark detector to determine two-dimensional positional data of one or more landmarks associated with the object; deriving, with a monocular pose estimator, first three-dimensional positional data of the one or more landmarks, using as input to the monocular pose estimator at least the first image, the two-dimensional positional data of the one or more landmarks, and parameters of the device; using the three-dimensional positional data of the one or more landmarks, determining coordinates of a second region of interest, the second region of interest indicating a position of the object as depicted in the second image; processing the area of the second image corresponding with the second region of interest with the landmark detector to determine two-dimensional positional data of one or more landmarks associated with the object; and using a triangulation calculation to derive second three-dimensional positional data for the one or more landmarks using as input to the triangulation calculation i) the two-dimensional positional data of the one or more landmarks determined from processing the area of the first image corresponding with the first region of interest, ii) the two-dimensional positional data of the one or more landmarks determined from processing the area of the second image corresponding with the second region of interest, and iii) parameters of the device.

In Example 2, the subject matter of Example 1 includes, a display device; wherein the object is a hand, and the memory is storing additional instructions thereon, which, when executed by the processor, cause the device to perform additional operations comprising: tracking the position and the orientation of the hand using the second three-dimensional positional data for the one or more landmarks.

In Example 3, the subject matter of Examples 1-2 includes, wherein deriving, with the monocular pose estimator, the first three-dimensional positional data of the one or more landmarks, further comprises: using as input to the monocular pose estimator a reference measurement representing an estimated length or distance between two specific landmarks; or using as input to the monocular pose estimator an estimated size of the object.

In Example 4, the subject matter of Example 3 includes, wherein the estimated length or distance between two specific landmarks represents an estimated length of a bone having as endpoints the two specific landmarks, the estimated length derived from the second three-dimensional positional data.

In Example 5, the subject matter of Examples 1-4 includes, wherein determining the coordinates of the second region of interest using the three-dimensional positional data of the one or more landmarks, comprises: using a rigid transformation matrix defined for the device to convert the three-dimensional positional data of the one or more landmarks from a coordinate system associated with the first image and first image sensor, to a coordinate system associated with the second image and second image sensor.

In Example 6, the subject matter of Examples 1-5 includes, wherein determining the coordinates of the second region of interest using the three-dimensional positional data of the one or more landmarks, comprises: computing the smallest rectangle that encloses all of the one or more landmarks after projecting the landmarks from a coordinate system associated with the first image and first image sensor, to a coordinate system associated with the second image and second image sensor.

In Example 7, the subject matter of Examples 1-6 includes, wherein determining the coordinates of the second region of interest using the three-dimensional positional data of the one or more landmarks, comprises: applying a scaling factor to the coordinates of the second region of interest that will enlarge the size of the second region of interest to account for inaccuracies that may have resulted from using the monocular pose estimator to derive the first three-dimensional positional data of the one or more landmarks.

In Example 8, the subject matter of Examples 1-7 includes, wherein processing the area of the first image corresponding with the first region of interest with the landmark detector to determine two-dimensional positional data of one or more landmarks associated with the object comprises identifying a single representative landmark via which the object can be transformed.

Example 9 is a computer-implemented method comprising: obtaining a first image from a first image sensor; obtaining a second image from a second image sensor; processing the first image with an object detector to identify coordinates of a first region of interest, the first region of interest indicating a position of an object depicted in the first image; processing the area of the first image corresponding with the first region of interest with a landmark detector to determine two-dimensional positional data of one or more landmarks associated with the object; deriving, with a monocular pose estimator, first three-dimensional positional data of the one or more landmarks, using as input to the monocular pose estimator at least the first image, the two-dimensional positional data of the one or more landmarks, and parameters associated with the first and second image sensors; using the three-dimensional positional data of the one or more landmarks, determining coordinates of a second region of interest, the second region of interest indicating a position of the object as depicted in the second image; processing the area of the second image corresponding with the second region of interest with the landmark detector to determine two-dimensional positional data of one or more landmarks associated with the object; and using a triangulation calculation to derive second three-dimensional positional data for the one or more landmarks using as input to the triangulation calculation i) the two-dimensional positional data of the one or more landmarks determined from processing the area of the first image corresponding with the first region of interest, ii) the two-dimensional positional data of the one or more landmarks determined from processing the area of the second image corresponding with the second region of interest, and iii) parameters associated with the first and second image sensors.

In Example 10, the subject matter of Example 9 includes, tracking the position and the orientation of a hand using the second three-dimensional positional data for the one or more landmarks, wherein the object is the hand.

In Example 11, the subject matter of Examples 9-10 includes, wherein deriving, with the monocular pose estimator, the first three-dimensional positional data of the one or more landmarks, further comprises: using as input to the monocular pose estimator a reference measurement representing an estimated length or distance between two specific landmarks; or using as input to the monocular pose estimator an estimated size of the object.

In Example 12, the subject matter of Example 11 includes, wherein the estimated length or distance between two specific landmarks represents an estimated length of a bone having as endpoints the two specific landmarks, the estimated length derived from the second three-dimensional positional data.

In Example 13, the subject matter of Examples 9-12 includes, wherein determining the coordinates of the second region of interest using the three-dimensional positional data of the one or more landmarks, comprises: using a rigid transformation matrix defined for the first and second image sensors to convert the three-dimensional positional data of the one or more landmarks from a coordinate system associated with the first image and first image sensor, to a coordinate system associated with the second image and second image sensor.

In Example 14, the subject matter of Examples 9-13 includes, wherein determining the coordinates of the second region of interest using the three-dimensional positional data of the one or more landmarks, comprises: computing the smallest rectangle that encloses all of the one or more landmarks after projecting the landmarks from a coordinate system associated with the first image and first image sensor, to a coordinate system associated with the second image and second image sensor.

In Example 15, the subject matter of Examples 9-14 includes, wherein determining the coordinates of the second region of interest using the three-dimensional positional data of the one or more landmarks, comprises: applying a scaling factor to the coordinates of the second region of interest that will enlarge the size of the second region of interest to account for inaccuracies that may have resulted from using the monocular pose estimator to derive the first three-dimensional positional data of the one or more landmarks.

In Example 16, the subject matter of Examples 9-15 includes, wherein processing the area of the first image corresponding with the first region of interest with the landmark detector to determine two-dimensional positional data of one or more landmarks associated with the object comprises identifying a single representative landmark via which the object can be transformed.

Example 17 is a system comprising: means for obtaining a first image; means for obtaining a second image; means for processing the first image to identify coordinates of a first region of interest, the first region of interest indicating a position of an object depicted in the first image; means for processing the area of the first image corresponding with the first region of interest to determine two-dimensional positional data of one or more landmarks associated with the object; means for deriving first three-dimensional positional data of the one or more landmarks, using as input at least the first image, the two-dimensional positional data of the one or more landmarks, and parameters of the system; means for determining coordinates of a second region of interest using the three-dimensional positional data of the one or more landmarks, the second region of interest indicating a position of the object as depicted in the second image; means for processing the area of the second image corresponding with the second region of interest to determine two-dimensional positional data of one or more landmarks associated with the object; and means for deriving second three-dimensional positional data for the one or more landmarks using as input i) the two-dimensional positional data of the one or more landmarks from the first image, ii) the two-dimensional positional data of the one or more landmarks from the second image, and iii) parameters of the system.

In Example 18, the subject matter of Example 17 includes, means for tracking the position and orientation of a hand using the second three-dimensional positional data for the one or more landmarks, wherein the object is the hand.

In Example 19, the subject matter of Examples 17-18 includes, wherein the means for deriving the first three-dimensional positional data of the one or more landmarks further comprises: means for using a reference measurement representing an estimated length or distance between two specific landmarks as input; or means for using an estimated size of the object as input.

In Example 20, the subject matter of Example 19 includes, wherein the reference measurement represents an estimated length of a bone having as endpoints the two specific landmarks, the estimated length derived from the second three-dimensional positional data.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components, also referred to as “computer-implemented.” Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A device comprising:
a processor;
a first image sensor;
a second image sensor; and
a memory storing instructions thereon, which, when executed by the processor, cause the device to perform operations comprising:
obtaining a first image from the first image sensor;
obtaining a second image from the second image sensor;
processing the first image with an object detector to identify coordinates of a first region of interest, the first region of interest indicating a position of an object depicted in the first image;
processing the area of the first image corresponding with the first region of interest with a landmark detector to determine two-dimensional (2-D) positional data of one or more landmarks associated with the object;
deriving, with a monocular pose estimator, first three dimensional (3-D) positional data of the one or more landmarks, using as input to the monocular pose estimator at least the first image, the 2-D positional data of the one or more landmarks, and parameters of the device;
using the 3-D positional data of the one or more landmarks, determining coordinates of a second region of interest, the second region of interest indicating a position of the object as depicted in the second image;
processing the area of the second image corresponding with the second region of interest with the landmark detector to determine 2-D positional data of one or more landmarks associated with the object; and
using a triangulation calculation to derive second 3-D positional data for the one or more landmarks using as input to the triangulation calculation i) the 2-D positional data of the one or more landmarks determined from processing the area of the first image corresponding with the first region of interest, ii) the 2-D positional data of the one or more landmarks determined from processing the area of the second image corresponding with the second region of interest, and iii) parameters of the device.

2. The device of claim 1, further comprising:
a display device;
wherein the object is a hand, and the memory is storing additional instructions thereon, which, when executed by the processor, cause the device to perform additional operations comprising:
tracking the position and the orientation of the hand using the second 3-D positional data for the one or more landmarks.

3. The device of claim 1, wherein deriving, with the monocular pose estimator, the first 3-D positional data of the one or more landmarks, further comprises:
using as input to the monocular pose estimator a reference measurement representing an estimated length or distance between two specific landmarks; or
using as input to the monocular pose estimator an estimated size of the object.

4. The device of claim 3, wherein the estimated length or distance between two specific landmarks represents an estimated length of a bone having as endpoints the two specific landmarks, the estimated length derived from the second 3-D positional data.

5. The device of claim 1, wherein determining the coordinates of the second region of interest using the 3-D positional data of the one or more landmarks, comprises:
using a rigid transformation matrix defined for the device to convert the 3-D positional data of the one or more landmarks from a coordinate system associated with the first image and first image sensor, to a coordinate system associated with the second image and second image sensor.

6. The device of claim 1, wherein determining the coordinates of the second region of interest using the 3-D positional data of the one or more landmarks, comprises:
computing the smallest rectangle that encloses all of the one or more landmarks after projecting the landmarks from a coordinate system associated with the first image and first image sensor, to a coordinate system associated with the second image and second image sensor.

7. The device of claim 1, wherein determining the coordinates of the second region of interest using the 3-D positional data of the one or more landmarks, comprises:
applying a scaling factor to the coordinates of the second region of interest that will enlarge the size of the second region of interest to account for inaccuracies that may have resulted from using the monocular pose estimator to derive the first 3-D positional data of the one or more landmarks.

8. The device of claim 1, wherein processing the area of the first image corresponding with the first region of interest with the landmark detector to determine 2-D positional data of one or more landmarks associated with the object comprises identifying a single representative landmark via which the object can be transformed.

9. A computer-implemented method comprising:
obtaining a first image from a first image sensor;
obtaining a second image from a second image sensor;
processing the first image with an object detector to identify coordinates of a first region of interest, the first region of interest indicating a position of an object depicted in the first image;
processing the area of the first image corresponding with the first region of interest with a landmark detector to determine two-dimensional (2-D) positional data of one or more landmarks associated with the object;
deriving, with a monocular pose estimator, first 3-D positional data of the one or more landmarks, using as input to the monocular pose estimator at least the first image, the 2-D positional data of the one or more landmarks, and parameters associated with the first and second image sensors;
using the 3-D positional data of the one or more landmarks, determining coordinates of a second region of interest, the second region of interest indicating a position of the object as depicted in the second image;
processing the area of the second image corresponding with the second region of interest with the landmark detector to determine 2-D positional data of one or more landmarks associated with the object; and
using a triangulation calculation to derive second 3-D positional data for the one or more landmarks using as input to the triangulation calculation i) the 2-D positional data of the one or more landmarks determined from processing the area of the first image corresponding with the first region of interest, ii) the 2-D positional data of the one or more landmarks determined from processing the area of the second image corresponding with the second region of interest, and iii) parameters associated with the first and second image sensors.

10. The computer-implemented method of claim 9, further comprising:
tracking the position and the orientation of a hand using the second 3-D positional data for the one or more landmarks, wherein the object is the hand.

11. The computer-implemented method of claim 9, wherein deriving, with the monocular pose estimator, the first 3-D positional data of the one or more landmarks, further comprises:
using as input to the monocular pose estimator a reference measurement representing an estimated length or distance between two specific landmarks; or
using as input to the monocular pose estimator an estimated size of the object.

12. The computer-implemented method of claim 11, wherein the estimated length or distance between two specific landmarks represents an estimated length of a bone having as endpoints the two specific landmarks, the estimated length derived from the second 3-D positional data.

13. The computer-implemented method of claim 9, wherein determining the coordinates of the second region of interest using the 3-D positional data of the one or more landmarks, comprises:
using a rigid transformation matrix defined for the first and second image sensors to convert the 3-D positional data of the one or more landmarks from a coordinate system associated with the first image and first image sensor, to a coordinate system associated with the second image and second image sensor.

14. The computer-implemented method of claim 9, wherein determining the coordinates of the second region of interest using the 3-D positional data of the one or more landmarks, comprises:
computing the smallest rectangle that encloses all of the one or more landmarks after projecting the landmarks from a coordinate system associated with the first image and first image sensor, to a coordinate system associated with the second image and second image sensor.

15. The computer-implemented method of claim 9, wherein determining the coordinates of the second region of interest using the 3-D positional data of the one or more landmarks, comprises:
applying a scaling factor to the coordinates of the second region of interest that will enlarge the size of the second region of interest to account for inaccuracies that may have resulted from using the monocular pose estimator to derive the first 3-D positional data of the one or more landmarks.

16. The computer-implemented method of claim 9, wherein processing the area of the first image corresponding with the first region of interest with the landmark detector to determine 2-D positional data of one or more landmarks associated with the object comprises identifying a single representative landmark via which the object can be transformed.

17. A system comprising:
means for obtaining a first image;
means for obtaining a second image;
means for processing the first image to identify coordinates of a first region of interest, the first region of interest indicating a position of an object depicted in the first image;
means for processing the area of the first image corresponding with the first region of interest to determine two-dimensional (2-D) positional data of one or more landmarks associated with the object;
means for deriving first 3-D positional data of the one or more landmarks, using as input at least the first image, the 2-D positional data of the one or more landmarks, and parameters of the system;
means for determining coordinates of a second region of interest using the 3-D positional data of the one or more landmarks, the second region of interest indicating a position of the object as depicted in the second image;
means for processing the area of the second image corresponding with the second region of interest to determine 2-D positional data of one or more landmarks associated with the object; and
means for deriving second 3-D positional data for the one or more landmarks using as input i) the 2-D positional data of the one or more landmarks from the first image, ii) the 2-D positional data of the one or more landmarks from the second image, and iii) parameters of the system.

18. The system of claim 17, further comprising:
means for tracking the position and orientation of a hand using the second 3-D positional data for the one or more landmarks, wherein the object is the hand.

19. The system of claim 17, wherein the means for deriving the first 3-D positional data of the one or more landmarks further comprises:
means for using a reference measurement representing an estimated length or distance between two specific landmarks as input; or
means for using an estimated size of the object as input.

20. The system of claim 19, wherein the reference measurement represents an estimated length of a bone having as endpoints the two specific landmarks, the estimated length derived from the second 3-D positional data.
